(19) United States
(12) Patent Application Publication
(10) Pub. No.: US 2025/0365719 A1
(43) Pub. Date: Nov. 27, 2025

(54) INFORMATION PROCESSING APPARATUS, CONTROL METHOD, AND NON-TRANSITORY STORAGE MEDIUM

(71) Applicant: CANON KABUSHIKI KAISHA, Tokyo (JP)

(72) Inventor: TSUBASA HIRANO, Kanagawa (JP)

(21) Appl. No.: 19/212,435

(22) Filed: May 19, 2025

(30) Foreign Application Priority Data
May 22, 2024 (JP) 2024-083429

(51) Int. Cl. H04W 72/0453; H04N 1/00; H04W 76/14

(52) U.S. Cl. CPC H04W 72/0453; H04W 76/14; H04N 1/00315

(57) ABSTRACT

An information processing apparatus includes a processor and a memory. The memory stores instructions for causing the processor and the memory to set an operation setting related to a direct wireless communication function to a first operation setting with which a negotiation is performed with the counterpart apparatus for determining which one is to be operated as an access point or to a second operation setting with which the information processing apparatus operates as the access point without the negotiation, as a second setting, set a frequency band used in the direct wireless communication by receiving an operation from a user, and control, when the first operation setting is set, to use any one of the plurality of frequency bands for the direct wireless communication, and when the second operation setting is set, to use the frequency band set by the second setting for the direct wireless communication.

### BACKGROUND

### Field of the Disclosure

The present disclosure relates to an information processing apparatus, a control method, and a non-transitory storage medium.

### Description of the Related Art

Due to the recent increase in the amount of data being communicated, the development of communication techniques, such as a wireless local area network (LAN), has been progressing. The Institute of Electrical and Electronics Engineers (IEEE) 802.11 standards series are known as the main communication standards for the wireless LAN. The IEEE802.11 standards series include IEEE802.11a/b/g/n/ac/ax standards. The IEEE802.11n/ac/ax standards can use a 2.4 gigahertz (GHz) frequency band and a 5 GHz frequency band for wireless LAN. There may be difference in communication quality between a plurality of frequency bands. Compared with the 2.4 GHz band, the 5 GHz band is not prone to radio frequency interference and generally provides high communication speed when the communication quality is stable. Thus, users tend to prefer the 5 GHz band.

As a communication method for the wireless LAN, there is infrastructure communication where apparatuses communicate with each other via an external access point. Further, there are forms, such as Wi-Fi Direct®, where apparatuses communicate directly with each other without using an external access point. Wi-Fi Direct® allows wireless communication between apparatuses on a one-to-one basis while one apparatus serves as the group owner (GO). The GO determines a frequency band used in Wi-Fi Direct®. Japanese Patent Application Laid-Open No. 2015-162859 discusses a technique in which an apparatus serves as a GO to connect its clients using a desired frequency band.

Apparatuses capable of direct wireless communication that support both the 2.4 GHz frequency band and the 5 GHz frequency band may not communicate suitably with the counterpart apparatuses.

### SUMMARY

Embodiments of the present disclosure are directed to a method for enabling an apparatus that supports both a 2.4 GHz frequency band and a 5 GHz frequency band to suitably perform communication.

According to an aspect of the present disclosure, an information processing apparatus is capable of performing communication at least in a 2.4 GHz band and a 5 GHz band, and capable of performing a direct wireless communication function for performing direct wireless communication with a counterpart apparatus without an external access point, and the information processing apparatus comprises at least one processor and at least one memory that is in communication with the at least one processor. The at least one memory stores instructions for causing the at least one processor and the at least one memory to set an operation setting related to the direct wireless communication function to a first operation setting with which a negotiation is performed with the counterpart apparatus for determining which of the information processing apparatus and the counterpart apparatus is to be operated as an access point to perform the direct wireless communication or to a second operation setting with which the information processing apparatus operates as the access point without the negotiation to perform the direct wireless communication, as a second setting, set a frequency band used in the direct wireless communication from among a plurality of frequency bands including the 2.4 GHz band and the 5 GHz band by receiving an operation from a user, and control the information processing apparatus, in a case where the information processing apparatus operates based on the first operation setting, to use any one of the plurality of frequency bands for the direct wireless communication, and in a case where the information processing apparatus operates based on the second operation setting, to use the frequency band set by the second setting for the direct wireless communication.

Further features of various embodiments will become apparent from the following description of exemplary embodiments with reference to the attached drawings.

### BRIEF DESCRIPTION OF THE DRAWINGS

FIG. 1 is a diagram illustrating a system configuration example.

FIG. 2 is a sequence diagram illustrating link establishments between access points (APs) and a station (STA).

FIG. 3 is a sequence diagram illustrating a Wi-Fi Direct® (WFD) connection.

FIG. 4 is a sequence diagram illustrating device discovery during the WFD connection.

FIG. 5 is a diagram illustrating a hardware configuration example of the APs and STA.

FIGS. 6A to 6C each illustrate a display example of a screen for performing direct wireless communication connection.

FIG. 7 is a flowchart of processing for performing the WFD connection.

FIG. 8 is a sequence diagram illustrating processing related to the WFD connection to which an exemplary embodiment is applied.

FIG. 9 illustrates a display example of a frequency setting screen.

### DESCRIPTION OF THE EMBODIMENTS

An exemplary embodiment of the present disclosure will now be described in detail with reference to the drawings.

### Configuration of Wireless Communication System

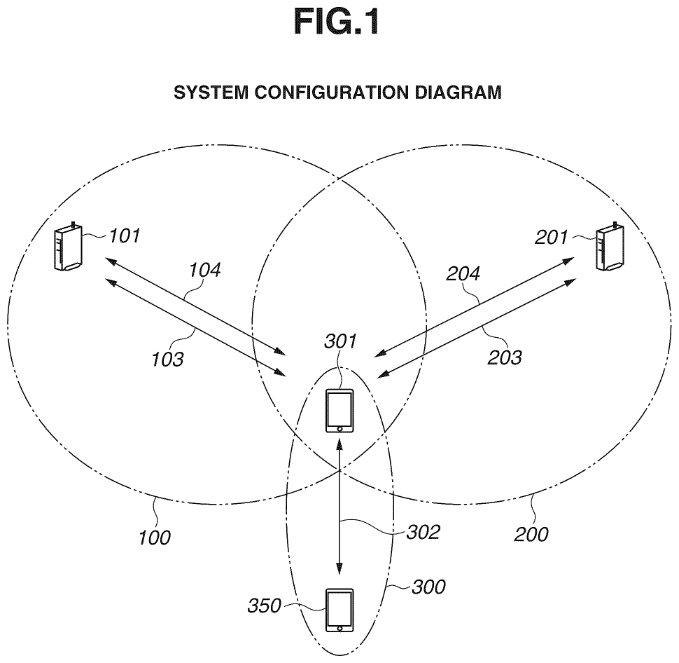

FIG. 1 illustrates a configuration example of a network according to the present exemplary embodiment. FIG. 1 illustrates a configuration including two access points (APs) 101 and 201, and two stations (STAs) 301 and 350. As illustrated in FIG. 1, a network formed by the AP 101 is depicted as a circle 100, a network formed by the AP 201 as a circle 200, and a network formed by the STA 301 as a circle 300. The STA 301 can transmit signals to and receive signals from the AP 101 and the AP 201. When an access point function of the STA 301 is enabled, the STA 301 forms the network 300, and the STA 301 can perform direct wireless communication (peer-to-peer communication) with the STA 350.

The STA 301 can participate in the networks formed by the AP 101 and the AP 201. The AP 101, the AP 201, the STA 301, and the STA 350 can perform wireless communication in compliance with Institute of Electrical and Electronics Engineers (IEEE) 802.11n/ac/ax standards or later standards. The communication apparatuses can each perform communication in a 2.4 gigahertz (GHz) frequency band, a 5 GHz frequency band, and a 6 GHz frequency band. A frequency band to be used by each communication apparatus is not limited thereto, and each communication apparatus can use any other frequency band, such as a 60 GHz band. Further, the AP 101, the AP 201, the STA 301, and the STA 350 can each perform communication by using bandwidths of 20 megahertz (MHz), 40 MHz, 80 MHz, 160 MHz, and 320 MHz. A bandwidth to be used by each communication apparatus is not limited thereto, and each communication apparatus can use any other bandwidth, such as 240 MHz and 4 MHz.

The AP 101, the AP 201, the STA 301, and the STA 350 each support the IEEE802.11n/ac/ax standards, but they may additionally support legacy standards that precede the IEEE802.11n/ac/ax standards. More specifically, the AP 101, the AP 201, the STA 301, and the STA 350 may each support at least one of the IEEE802.11a/b/g/n/ac/ax standards. The AP 101, the AP 201, the STA 301, and the STA 350 may each support other communication standards, such as Bluetooth®, near field communication (NFC), ultra wide band (UWB), ZigBee, and multiband OFDM alliance (MBOA), in addition to the IEEE802.11 series standards. The UWB includes wireless universal serial bus (USB), wireless 1394, and WiNet. Further, the AP 101, the AP 201, the STA 301, and the STA 350 may each support standards of wired communication, such as a wired local area network (LAN). Examples of the AP 101 and the AP 201 include wireless LAN routers and personal computers (PCs), but are not limited thereto. The AP 101 can be an information processing apparatus, such as a wireless chip, performing wireless communication in compliance with the IEEE802.11n/ac/ax standards. Examples of the STA 301 and the STA 350 include information processing apparatuses, such as printers, multifunctional peripherals, cameras, tablets, smartphones, PCs, mobile phones, video cameras, or headsets, but are not limited thereto. The STA 301 and the STA 350 can each be an information processing apparatus, such as a wireless chip, performing wireless communication in compliance with the IEEE802.11 n/ac/ax standards.

The AP 101, the AP 201, the STA 301, and the STA 350 can each perform an infrastructure mode in which one of a plurality of frequency bands is selected to establish connection and perform communication. For example, the AP 101 has a link 103 in a first frequency band of the 5 GHz frequency band and a link 104 in a second frequency band of the 2.4 GHz frequency band. The AP 201 includes a link 203 in the first frequency band of the 5 GHz frequency band and a link 204 in the second frequency band of the 2.4 GHz frequency band. The STA 301 establishes connection using information, such as a service set identifier (SSID) assigned to each of the links of the APs. The AP 101 and the AP 201 can set the same SSID for links in the frequency bands. The STA 301 identifies each link from the basic service set identifier (BSSID) included in packets transmitted by the APs and the frequency band.

The STA 301 supports the infrastructure mode that is an operation setting for performing infrastructure communication with a communication terminal via the external AP 101 or 201. In the infrastructure mode, the STA 301 supports the 2.4 GHz frequency band, the 5 GHz frequency band, and the 6 GHz frequency band. In the infrastructure mode, the STA 301 communicates in the 2.4 GHz, the 5 GHz, or the 6 GHz frequency bands based on the external AP connected thereto. In other words, the frequency band used for the STA 301 in the infrastructure mode is determined by the external AP.

The STA 301 supports a direct wireless communication function of performing direct wireless communication with communication terminals without using external APs. The direct wireless communication operates with two types of operation settings. One is a Wi-Fi Direct® (WFD) mode complying with the WFD standard defined by Wi-Fi Alliance. In the WFD mode, through a negotiation with a counterpart apparatus, it is determined which apparatus will become a group owner (GO), and then the direct wireless communication is performed. The GO operates as an AP to perform direct wireless communication with the counterpart apparatus. The other is an AP mode where the STA 301 operates as a fixed AP without performing the above-described negotiation. The AP mode is also referred to as a software AP mode.

The AP mode may not comply with the WFD standard. The STA 301 supports the infrastructure mode, the WFD mode, and the AP mode. For example, the STA 301 can operate in the infrastructure mode and the AP mode in parallel or simultaneously. Further, the STA 301 can operate in the infrastructure mode and in the WFD mode in parallel or simultaneously.

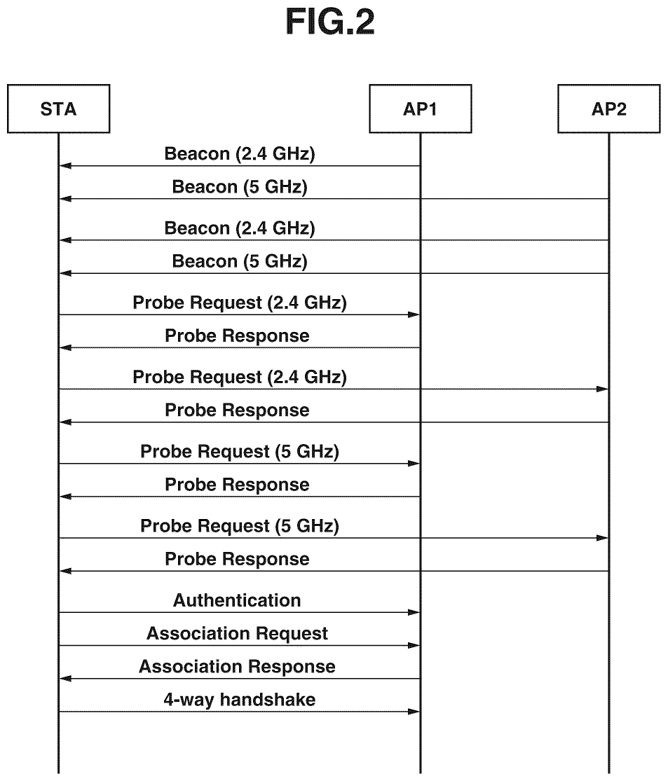

FIG. 2 is a sequence diagram of the STA establishing links with the external APs, and FIG. 2 illustrates the communication connection in the above-described infrastructure mode. The APs transmit beacons to make their presence known to the STA. The STA transmits a probe request to the APs and receives a probe response from the APs to determine that a link establishment can be started. The STA and the APs establish links through an authentication communication (Authentication to 4-way handshake). The above is a description of the connection sequence with the external APs when the STA 301 operates in the infrastructure mode. When operating in the AP mode, the STA 301 serves as the AP in the above-described sequence to perform direct wireless communication connection with a communication terminal.

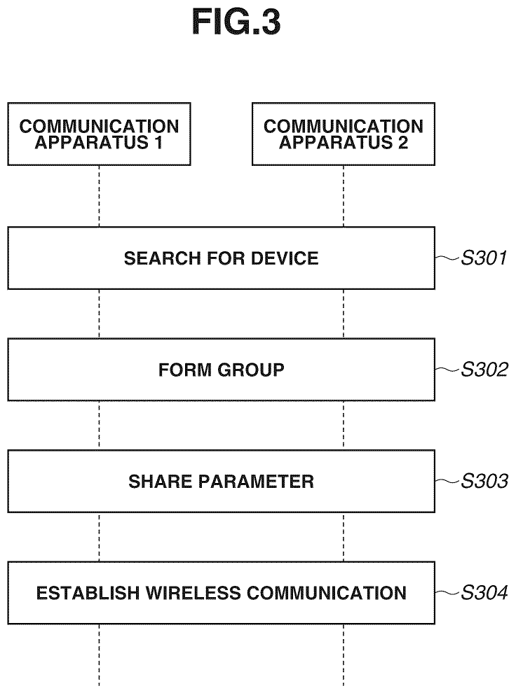

FIG. 3 illustrates an example of a WFD connection sequence. A communication apparatus 1 and a communication apparatus 2 are, for example, the STA 301 and the STA 350 illustrated in FIG. 1.

In step S301, the communication apparatus 1 and the communication apparatus 2 each perform device discovery to recognize the presence of each other. Detailed processing of this device discovery will be described below.

In step S302, a group is formed, and the communication apparatus 1 or the communication apparatus 2 becomes the GO. For example, the communication apparatus 1 transmits a GO negotiation request including an intent value, and the communication apparatus 2 transmits a GO negotiation response including an intent value. The intent value is an index value indicating the degree to which an apparatus should become the GO, and is set within the numerical value range of 0 to 15. The apparatus having a higher intent value becomes the GO, and the other becomes a client (CL).

In step S303, parameters for communication connection are shared. In step S304, mutual authentication is performed using the parameters shared in step S303, and wireless communication is established. As an authentication protocol, for example, WPA2-Personal can be used.

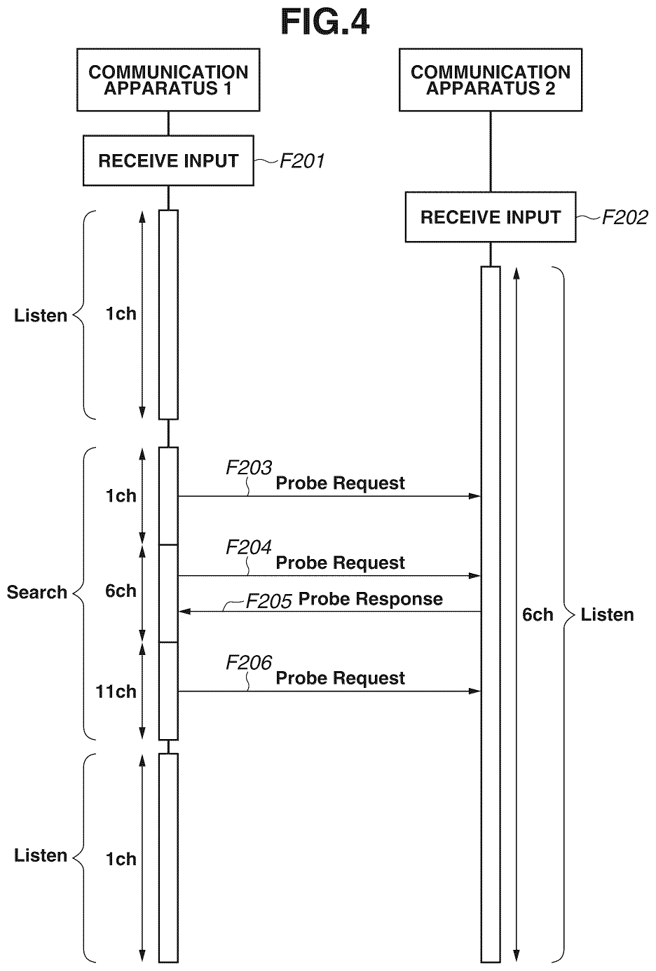

FIG. 4 illustrates a sequence example of searching for a counterpart apparatus for a WFD connection. The device discovery operation in step S301 in FIG. 3 will be described in detail.

In step F201 or F202, the communication apparatuses each start a detection procedure based on an input from a user or an application. When receiving an instruction for detecting another communication apparatus from the user, the communication apparatus 1 attempts to detect the other communication apparatus by repeating a listen state and a search state. In the present exemplary embodiment, an example in which the communication apparatus 1 first performs the listen state is described. However, the communication apparatus 1 can perform the search state first. Before these states, a period when channels are scanned (all channel scanning) can be provided. For example, in the listen state, the communication apparatus 1 selects channel 1 in the 2.4 GHz band, and waits for a probe request frame from the other communication apparatus. The communication apparatus 1 selects channel 1 here, but can select a channel in the 5 GHz band. A period of the listen state can be, for example, N times a unit period TU (which is the abbreviation of time unit) that is a predetermined period. In other words, the period of the listen state can be expressed as N×TU. The TU can be, for example, 100 milliseconds. The value N can be an integer of 1 or more determined by a random number. The value N can be a predetermined value via settings, and the value N can vary for each frequency channel. When transiting from the listen state to the search state, the communication apparatus 1 transmits probe requests while switching the frequency channels and waits for probe response frames in steps F203, F204, and F206. The communication apparatus 1 here transmits probe request frames on channels 1, 6, and 11 in the 2.4 GHz band, but the communication apparatus 1 may transmit a probe request frame on channel 36 in the 5 GHz band. Probe request frames can be transmitted on a single channel or a plurality of channels. For example, the communication apparatus 1 may transmit probe request frames on channel 6 alone in the 2.4 GHz band or on all channels in the 2.4 GHz, the 5 GHz, and the 6 GHz bands. The communication apparatus 1 may transition back to the listen state from the search state.

On the other hand, when receiving an instruction for detecting another communication apparatus from the user, the communication apparatus 2 attempts to detect the other communication apparatus by repeating the listen state and the search state, in a manner similar to the communication apparatus 1. For example, in the listen state, the communication apparatus 2 selects channel 6 in the 2.4 GHz band and waits for a probe request frame from the other communication apparatus. In this case, while the communication apparatus 2 is waiting on channel 6 in the listen state, the communication apparatus 1 transitions to the search state and transmits a probe request frame on channel 6. The communication apparatus 2 transmits a probe response frame in response to a reception of the probe request frame in step F205. Probe responses include the terminal names of the sending terminals. The terminal name can be used to identify the terminal that has transmitted the probe response frame. Probe request frames can be received on a single channel or a plurality of channels. For example, the communication apparatus 2 may wait for probe request frames on channel 6 alone in the 2.4 GHz band or on all channels in the 2.4 GHz, the 5 GHz, and the 6 GHz bands.

The communication apparatus 1 receives a probe response frame to detect the communication apparatus 2. The communication apparatus 2 receives a probe request frame to detect the communication apparatus 1. The communication apparatus 1 and the communication apparatus 2 can each report to the user that they have detected the communication apparatus 2 and the communication apparatus 1, respectively. For example, a notification that a counterpart apparatus has been detected is displayed on an operation screen. In this manner, a communication apparatus can detect another communication apparatus by using probe request frames and probe response frames while repeatedly transitioning between the listen state and the search state.

### Configuration of AP and STA

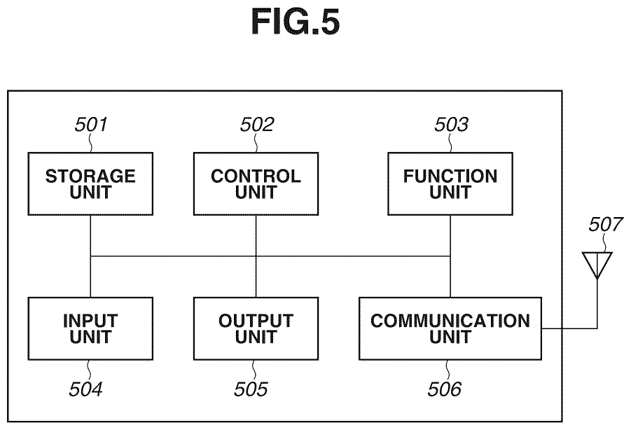

FIG. 5 illustrates a hardware configuration example of the STA 301 according to the present exemplary embodiment. The STA 301 includes a storage unit 501, a control unit 502, a function unit 503, an input unit 504, an output unit 505, a communication unit 506, and an antenna 507. The STA 301 can include a plurality of antennae.

The storage unit 501 includes one or more memories, such as a read-only memory (ROM) and a random-access memory (RAM). The storage unit 501 stores computer programs for performing various kinds of operation described below and stores various kinds of information, such as communication parameters for wireless communication. As the storage unit 501, in addition to the memories, such as the ROM and the RAM, a storage medium, such as a flexible disk, a hard disk, an optical disk, a magnetooptical disk, a compact disk-read-only memory (CD-ROM), a compact disk-recordable (CD-R), a magnetic tape, a nonvolatile memory card, or a digital versatile disk (DVD), can be used. Further, the storage unit 501 can include a plurality of memories.

The control unit 502 includes one or more processors, such as a central processing unit (CPU) and a micro-processing unit (MPU), and runs computer programs stored in the storage unit 501 to control the STA 301. The control unit 502 can control the STA 301 by cooperating with the computer programs and an operating system (OS) stored in the storage unit 501. In addition, the control unit 502 generates data and signals (wireless frames) to be transmitted in communication with another communication apparatus. The control unit 502 can include a plurality of processors, such as a multicore processor, to control the STA 301.

The control unit 502 controls the function unit 503 to perform predetermined processing, such as wireless communication, imaging, printing, or projection. The function unit 503 is hardware for the STA 301 to perform the predetermined processing. It is on the assumption that the STA 301 is an image processing apparatus including a printer and a scanner in the function unit 503. The STA 301 prints print data received from an external terminal via the communication unit 506 by using the printer, and the STA 301 transmits image data generated by scanning a document with the scanner to the external terminal via the communication unit 506. The STA 301 can be an image processing apparatus that has a single function of either printing or scanning.

The input unit 504 receives various kinds of operations from the user. The output unit 505 performs various kinds of outputs to the user via a monitor screen and a speaker. The outputs from the output unit 505 can include display on the monitor screen, audio output through the speaker, and vibration output. The input unit 504 and the output unit 505 can be implemented in a single module, such as a touch panel. Further, the input unit 504 and the output unit 505 can be integrated with the STA 301 or separated from the STA 301.

The communication unit 506 controls wireless communication in compliance with the IEEE 802.11 series standards. The communication unit 506 controls the antenna 507 to transmit and receive signals for wireless communication generated by the control unit 502. When supporting NFC standards and Bluetooth® standards in addition to the IEEE 802.11 series standards, the communication unit 506 can control wireless communication in compliance with those communication standards. When the STA 301 is capable of performing wireless communication in compliance with a plurality of communication standards, the STA 301 may have a configuration with a separate communication unit and antenna for each communication standard. The STA 301 exchanges data, such as image data, document data, and video data, with an external terminal via the communication unit 506. The antenna 507 can be separated from the communication unit 506 or, alternatively, can be integrated with the communication unit 506 into a single module. The antenna 507 can perform communication in the 2.4 GHz, the 5 GHz, and the 6 GHz bands. In the present exemplary embodiment, the STA 301 includes one antenna, but the STA 301 can include a plurality of antennae.

The AP 101, the AP 201, and the STA 350 each have a hardware configuration similar to that of the STA 301. While the STA 301 includes one antenna 507, the AP 101 and the AP 201 can include different antennae corresponding to the respective frequency bands. When the AP 101 and the AP 201 each include a plurality of antennae, the AP 101 and the AP 201 can have communication units 506 corresponding to the respective antennae.

### Processing Procedure

Subsequently, a procedure of processing performed by the above-described APs and STAs and a sequence in the wireless communication system according to the present exemplary embodiment will be described.

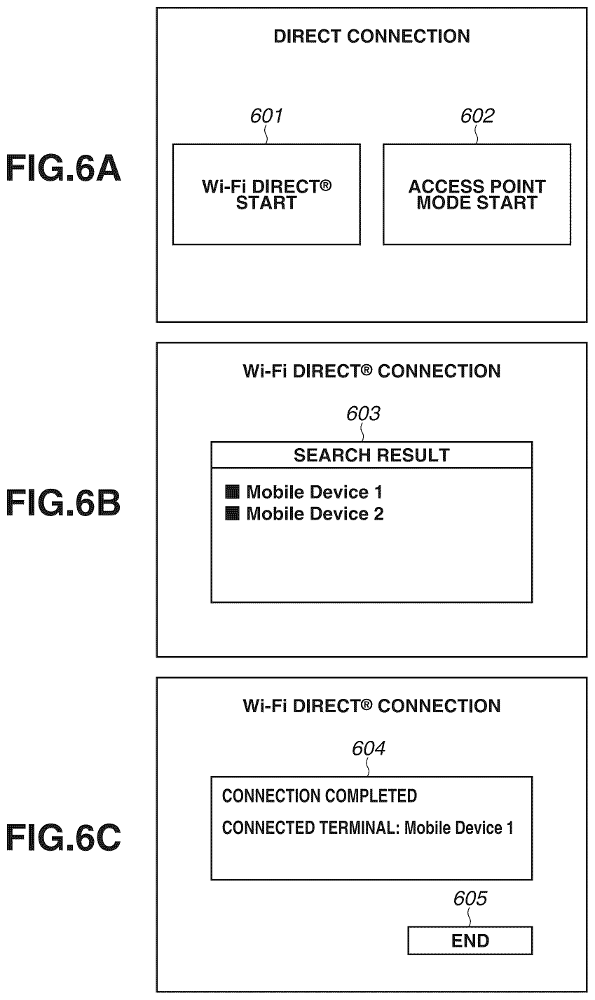

FIGS. 6A to 6C each illustrate a screen example when the STA 301 establishes direct wireless communication connection with another terminal. The screen is output by the output unit 505 of the STA 301. A screen illustrated in FIG. 6A is a start screen for selecting the WFD mode or the AP mode in order to start the direct wireless communication connection. When the user presses a button 601 (corresponding to step F201), the STA 301 starts the WFD mode. More specifically, the STA 301 starts the search sequence illustrated in FIG. 4 and displays a screen illustrated in FIG. 6B. When the user presses a button 602, the STA 301 starts operation in the AP mode, transmits a beacon, and waits for reception of a connection request from another STA.

The screen illustrated in FIG. 6B displays a WFD device discovery result. A list of devices found during device discovery is displayed in a search result display region 603. Device discovery is performed while this screen is displayed, and newly found devices are added and displayed as they are discovered. When the user selects a displayed device name, for example, the processing in and after step S302 in FIG. 3 is performed to cause the STA 301 to perform WFD connection processing.

A screen illustrated in FIG. 6C indicates that the user has selected “Mobile Device 1” on the screen illustrated in FIG. 6B, and a WFD connection with the terminal having the device name “Mobile Device 1” is established. A message indicating the connection is established and information about the connected terminal are displayed in a display region 604. In the present exemplary embodiment, the device name is displayed as the information on the terminal, but a media access control (MAC) address, an internet protocol (IP) address of the terminal, and information indicating whether the terminal serves as a GO or CL can be displayed. A button 605 is used to end the WFD connection. Pressing the button 605 disconnects the WFD connection with the terminal and returns to the screen illustrated in FIG. 6A.

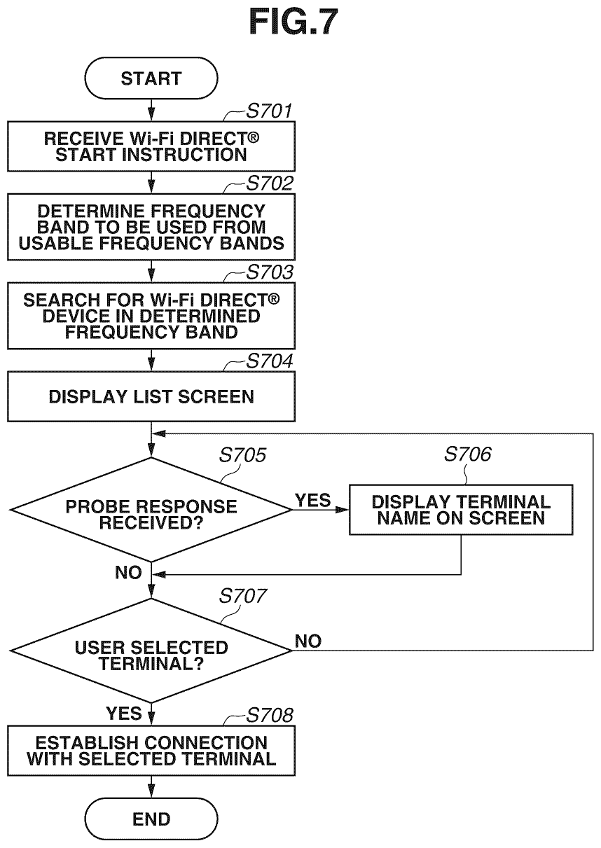

FIG. 7 is a flowchart of processing for the STA 301 to perform a WFD connection according to the present exemplary embodiment.

When the user presses the button 601 in the screen illustrated in FIG. 6A, in step S701, the input unit 504 detects the press of the button 601, and the control unit 502 starts a WFD connection operation. In step S702, the control unit 502 determines one frequency band to be used for the WFD from the frequency bands supported by the STA 301. For example, the STA 301 can perform communication in the 2.4 GHz, 5 GHz, and 6 GHz bands. In the infrastructure mode, the STA 301 can establish connections in any of the frequency bands, but, in the WFD connection, the STA 301 uses one frequency band alone. The frequency band determined at this time can be any frequency band supported by the STA 301. For example, to perform a fixed WFD connection in the 2.4 GHz band, the 2.4 GHz frequency band is determined to be used for device discovery or communication connections. In step S703, the control unit 502 performs WFD device discovery in the frequency band determined in step S702. In other words, the control unit 502 searches for a counterpart apparatus in the determined frequency band in the listen state and the search state. In this example, one frequency band is determined to be the frequency band used for the WFD. However, a plurality of frequency bands can be determined.

In step S704, the output unit 505 displays the screen illustrated in FIG. 6B. At this stage, the terminals found in the search result display region 603 are not yet displayed. In step S705, the control unit 502 checks whether a probe response is received as a result of the device discovery in step S703. If a probe response is received (YES in step S705), the processing proceeds to step S706. In step S706, the control unit 502 acquires the terminal name of the sending terminal from the received probe response, and the control unit 502 displays the terminal names of the found terminals in the search result display region 603 in the screen illustrated in FIG. 6B. Thereafter, the processing proceeds to step S707. If a probe response is not received in step S705 (NO in step S705), the processing proceeds to step S707.

In step S707, the input unit 504 determines whether the user selects a terminal displayed in the search result display region 603 in the screen illustrated in FIG. 6B. If the user does not select a terminal (NO in step S707), the processing returns to step S705 and the control unit 502 continuously checks reception of a probe response frame. If the user has selected a terminal (YES in step S707), the processing proceeds to step S708.

In step S708, a communication connection with the selected terminal is performed. More specifically, the operations of the group formation, the parameter sharing, and the connection in steps S302, S303, and S304 in FIG. 3 are performed to establish a WFD connection with the counterpart terminal. Here, the WFD connection uses the same frequency band or channel as that used in the transmission of the probe request. For example, if the STA 301 becomes the GO, a network is configured using the frequency band or channel used during the discovery phrase. Even if the STA 3 becomes the CL, information about the frequency band or the channel used during the device discovery can be notified to the counterpart apparatus in step S302 to configure the network in the WFD connection using the frequency band or the channel. Here, a case is described where the frequency band (or channel) of the 2.4 GHz determined in step S702 is used in the discovery phase and in the WFD connection. In the present exemplary embodiment, the frequency band is not limited thereto.

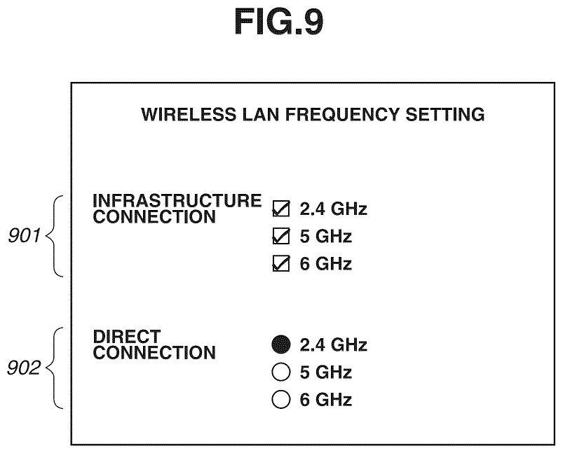

For example, the frequency bands (or channels) of the 2.4 GHz, the 5 GHz, and the 6 GHz can be used during the discovery phase, and the frequency band (or channel) of the 2.4 GHz determined in step S702 can be used in the WFD connection. For example, the frequency bands (or channel) of the 2.4 GHz, the 5 GHz, and the 6 GHz determined in step S702 can be used during the discovery phase and in the WFD connection. In other words, the frequency bands determined in step S702 can be used both during the discovery phase and in the WFD connection. When the connection is established, the output unit 505 displays the connection establishment screen illustrated in FIG. 6C. It is on the assumption that the frequency band determined in step S702 is previously set (e.g., at the time of factory shipment) as a fixed apparatus setting of the STA 301, but the frequency band is not limited thereto. The frequency band determined in step S702 may not be fixed in the STA 301, can be dynamically changed depending on the apparatus state, or appropriately set by the user in a setting screen as illustrated in FIG. 9.

With the above-described procedure, even if the apparatus supports the frequency bands of the 2.4 GHz, the 5 GHz, and the 6 GHz, the WFD discovery or connection in the WFD is performed in one frequency band alone. This makes it possible to save resources related to communication connection.

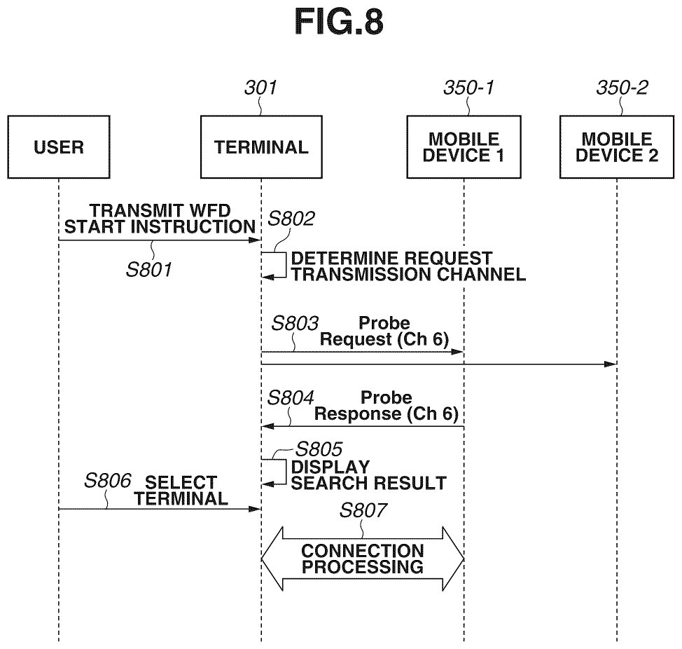

FIG. 8 is a sequence diagram according to the present exemplary embodiment (a sequence diagram illustrating processing related to the WFD connection to which the present exemplary embodiment is applied). STAs 350-1 and 350-2 are terminals having terminal names Mobile Device 1 and Mobile Device 2, respectively. The STA 350-1 is in a state where a WFD communication can be performed in the 2.4 GHz band alone and a probe request can be received. The STA 350-2 is in a state where a WFD communication can be performed in the 5 GHz band alone and a probe request can be received.

In step S801, the user presses the button 601 in the screen illustrated in FIG. 6A displayed on the STA 301. In step S802, the STA 301 determines a communication channel used for the transmission of probe requests. The determination corresponds to that in step S702.

For example, the STA 301 determines to use the 2.4 GHz frequency band. Thereafter, the STA 301 uses the communication unit 506 to transmit a probe request to the surrounding devices. At this time, the STA 301 transmits the probe request on the frequency band determined in step S802. In this case, since the 2.4 GHz band is determined to be used, the STA 301 transmits the probe request on channel 6. The STA 301 can transmit the probe request on a channel other than channel 6 as long as the channel is in the frequency band determined in step S802. For example, the STA 301 can transmit the probe request on channels 1, 6, and 11 that are representative channels of the 2.4 GHz band, or the STA 301 can transmit the probe request on all channels from 1 to 13.

The STA 350-1 waits for a probe request in the WFD in the 2.4 GHz band. In step S803, thus, the STA 350-1 receives the probe request transmitted, and in step S804, the STA 350-1 transmits a probe response. On the other hand, the STA 350-2 waits for a probe request in the 5 GHz band alone. Thus, the STA 350-2 can neither receive the probe request transmitted in step S803 nor transmit a probe response.

After transmitting the probe request, the STA 301 displays the discovery result screen illustrated in FIG. 6B in step S805. At this time, since the probe response is received in step S804, the STA 301 acquires the terminal name of the sending terminal from the received probe response and displays the terminal name of the STA 350-1 on the screen.

In step S806, the user checks the result displayed in step S805, and selects the terminal name of the terminal to be connected. In the present exemplary embodiment, the user selects Mobile Device 1. In step S807, the STA 301 performs connection processing with the selected terminal Mobile Device 1. The connection processing is performed using the same frequency band as that used in the transmission of the probe request. Thereafter, the STA 301 establishes a WFD connection with the terminal Mobile Device 1 by using the same frequency band as that used in the transmission of the probe request. The WFD connection is not limited thereto as long as a WFD connection is performed in the frequency band determined in step S702.

In the above-described manner, the device discovery is performed in a specific frequency band alone, and connection with the found STA is performed using the same frequency band as that in the device discovery. Even when the apparatus supports a plurality of frequency bands, such as the 2.4 GHz band and the 5 GHz band, the WFD connection is performed in either the 2.4 GHz frequency band or the 5 GHz frequency band. This makes it possible to simplify the control related to the communication connection of the apparatus and to suitably perform communication.

The determination of the frequency band in steps S702 and S802 may not be performed every time, and the frequency band can be previously determined to be, for example, the 2.4 GHz band.

Further, the frequency band determined in steps S702 and S802 can be set by the user. FIG. 9 illustrates an example of a frequency band setting screen provided by the STA 301. The screen can be displayed on a display unit of the STA 301, or the screen can be displayed on an external terminal communicating with the STA 301. In the screen illustrated in FIG. 9, the frequency band used for the wireless LAN communication of the STA 301 can be set.

An infrastructure mode connection setting 901 displays frequency bands usable in the infrastructure connection where the STA 301 serving as a secondary unit is connected to an external AP. In the present exemplary embodiment, the frequency band can be selected from the 2.4 GHz, the 5 GHz, and the 6 GHz. It is on the assumption that a plurality of frequency bands is selectable. However, a configuration can be applied in which one or two frequency bands alone are selectable. The STA 301 is connected to the external AP supporting the frequency band set in the infrastructure mode connection setting 901.

On the other hand, the direct connection setting 902 allows the user to select a frequency band to be used in the direct wireless communication connection from the 2.4 GHz band, the 5 GHz band, and the 6 GHz band. In the present exemplary embodiment, it is on the assumption that one frequency band can be selected from the plurality of frequency bands. The frequency band selected in the direct connection setting 902 can be used for the device discovery and the connection in both the WFD mode and the AP mode and can be used for the device discovery and the connection in either the WFD mode or the AP mode. For example, when the 2.4 GHz band is set in the direct connection setting 902, the frequency band for the device discovery determined in steps S702 and S802 and the frequency band used in the connection in steps S708 and S807 are the 2.4 GHz band. In the infrastructure mode connection setting 901 and the direct connection setting 902, while the frequency band to be used is settable, a channel to be used can be set.

Settings in the frequency band setting screen illustrated in FIG. 9 and an operation pattern of the STA 301 will now be described.

The following is a description of an operation where the 2.4 GHz band, the 5 GHz band, and the 6 GHz band are set in the infrastructure mode connection setting 901, the 5 GHz band is set in the direct connection setting 902, and those settings are applied to the AP mode alone. In the infrastructure mode, the STA 301 can establish connections in the 2.4 GHz frequency band, the 5 GHz frequency band, and the 6 GHz frequency band. The STA 301 operates in the 5 GHz frequency band in the AP mode and operates in the 2.4 GHz frequency band in the WFD mode. In other words, the STA 301 can connect to the external APs that operate in the 2.4 GHz, the 5 GHz, and the 6 GHz frequency bands. In the AP mode, the STA 301 configures the network in the 5 GHz band, and the STA 301 performs direct wireless communication with the counterpart apparatus in the 5 GHz band. In the WFD mode, the STA 301 performs a WFD connection with (or search for) the counterpart apparatus in the 2.4 GHz band. In this case, the STA 301 operates based on the settings in FIG. 9 in the infrastructure mode and the AP mode, while in the WFD mode, the STA 301 uses the 2.4 GHz band that is previously set as an apparatus setting of the STA 305. In the WFD mode, the STA 301 may use the 2.4 GHz band for the communication connection with the counterpart apparatus alone, or for both the communication connection with the counterpart apparatus and the WFD device discovery. In the present exemplary embodiment, the previously-set 2.4 GHz band is used in the WFD mode. However, the 5 GHz band (or the 6 GHz band) can be set previously to be used. In the infrastructure mode, the frequency band is based on the infrastructure mode connection setting 901, but a connection can be performed in the 2.4 GHz, the 5 GHz, and the 6 GHz frequency bands in the infrastructure mode without the infrastructure mode connection setting 901. Further, the STA 301 can perform the operations in the infrastructure mode and the operation in the AP mode at the same time. For example, the STA 301 can operate in the 2.4 GHz band in the infrastructure mode and operate in the 5 GHz band in the AP mode at the same time. In other words, the STA 301 can perform direct communication with the STA 350 in the 5 GHz frequency band while performing communication with the external AP in the 2.4 GHz frequency band. In the present exemplary embodiment, the STA 301 can perform operations in the infrastructure mode and in the AP mode at the same time. However, the STA 301 can perform operations in the infrastructure mode and in the WFD mode at the same time, or the STA 301 can perform operations in the AP mode and in the WFD mode at the same time.

As another example, the following is a description of an operation where the 2.4 GHz band, the 5 GHz band, and the 6 GHz band are set in the infrastructure mode connection setting 901; where the 5 GHz band is set in the direct connection setting 902; and where those settings are applied to the AP mode and the WFD mode. In the infrastructure mode, the STA 301 can establish a respective connection in any of the 2.4 GHz band, the 5 GHz band, and the 6 GHz band. In the AP mode and the WFD mode, the STA 301 operates in the 5 GHz band. The operations in the AP mode and in the WFD mode are performed based on the setting in the direct connection setting 902. Thus, the frequency bands used in the AP mode and in the WFD mode can be aligned with each other. In the WFD mode, the STA 301 can use the 5 GHz band for the communication connection alone with the counterpart apparatus, and the STA 301 can use the 2.4 GHz band for the WFD device discovery. The STA 301 can use the 5 GHz band for both the communication connection with the counterpart apparatus and the WFD device discovery. Even in this case, the above-described simultaneous operation is performable. For example, the STA 301 can operate in the 5 GHz band in the infrastructure mode, and the STA 301 can operate in the 2.4 GHz band in the AP mode or the WFD mode at the same time.

In the present exemplary embodiment, the infrastructure mode connection setting 901 and the direct connection setting 902 are provided. However, the setting is not limited thereto. The frequency band to be used can be each set in the infrastructure mode, the AP mode, and the WFD mode among the 2.4 GHz, the 5 GHz, and the 6 GHz bands. While, in the present exemplary embodiment, a frequency band to be used is selected from the three frequency bands of the 2.4 GHz, the 5 GHz, and the 6 GHz. However, a frequency band can be selected from items corresponding to the two frequency bands of the 2.4 GHz and the 5 GHz.

### Other Exemplary Embodiment

The various kinds of control described as the control performed by the communication apparatus in the above-described exemplary embodiment can be performed by a single piece of hardware, or a plurality of pieces of hardware (e.g., a plurality of processors and circuits) can share the processing to control the entire apparatus.

While the present disclosure has described an exemplary embodiment in detail, some embodiments are not limited to the specific exemplary embodiment. Various embodiments without departing from the spirit of the present disclosure are also included in the present disclosure. Further, the above-described exemplary embodiment is merely an example, and the exemplary embodiments can be appropriately combined.

In the above-described exemplary embodiment, a case where the present disclosure is applied to the STAs and the APs as the communication apparatuses is described as an example, but some embodiments are not limited thereto. The present disclosure is applicable to any wireless apparatus. In other words, the present disclosure is applicable to a personal computer, a personal digital assistant (PDA), a tablet terminal, a mobile phone terminal (e.g., a smartphone), a music player, a game machine, an electronic book reader, a smart watch, and various kinds of measurement devices (sensor devices) (e.g., a thermometer and a hygrometer). The present disclosure is also applicable to a digital camera (including a still camera, a video camera, a network camera, and a security camera), a printer, a scanner, and a drone. The present disclosure is also applicable to a video output apparatus, an audio output apparatus (e.g., a smart speaker), a media streaming player, and a wireless LAN secondary unit (adapter) connectable via a USB terminal or a LAN cable terminal. The video output apparatus includes, for example, an apparatus that obtains (downloads) a video from the Internet identified by a uniform resource locator (URL) instructed from an electronic apparatus and that outputs the video to a display apparatus connected via a video output terminal, such as a High-Definition Multimedia Interface (HDMI®), enabling a streaming playback on the display apparatus or a mirroring display (display that causes the display apparatus to display contents displayed on the electronic apparatus). In addition, the video output apparatus includes a television, a media player (e.g., a hard disk recorder, a Blu-ray recorder, or a DVD recorder), a head-mounted display, a projector, a display apparatus (a monitor), and a signage apparatus. The present disclosure is also applicable to a Wi-Fi-connectable apparatus that is a so-called smart home appliance, such as an air conditioner, a refrigerator, a washing machine, a vacuum cleaner, an oven, a microwave oven, a lighting apparatus, a heater, and a cooler.

As described above, according to the exemplary embodiment, an apparatus supporting both frequency bands of the 2.4 GHz and the 5 GHz can suitably perform communication.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-083429, which was filed on May 22, 2024 and which is hereby incorporated by reference herein in its entirety.

What is claimed is:

1. An information processing apparatus capable of performing communication at least in a 2.4 GHz band and a 5 GHz band, and capable of performing a direct wireless communication function for performing direct wireless communication with a counterpart apparatus without an external access point, the information processing apparatus comprising:
at least one processor; and
at least one memory that is in communication with the at least one processor, wherein the at least one memory stores instructions for causing the at least one processor and the at least one memory to:
set an operation setting related to the direct wireless communication function to a first operation setting with which a negotiation is performed with the counterpart apparatus for determining which of the information processing apparatus and the counterpart apparatus is to be operated as an access point to perform the direct wireless communication or to a second operation setting with which the information processing apparatus operates as the access point without the negotiation to perform the direct wireless communication;
as second setting, set a frequency band used in the direct wireless communication from among a plurality of frequency bands including the 2.4 GHz band and the 5 GHz band by receiving an operation from a user; and
control the information processing apparatus, in a case where the information processing apparatus operates based on the first operation setting, to use any one of the plurality of frequency bands for the direct wireless communication, and in a case where the information processing apparatus operates based on the second operation setting, to use the frequency band set by the second setting for the direct wireless communication.

2. The information processing apparatus according to claim 1, wherein the at least one memory further stores instructions for causing the at least one processor and the at least one memory to, in the case where the information processing apparatus operates based on the first operation setting, use the 2.4 GHz band for the direct wireless communication irrespective of the setting by the second setting.

3. The information processing apparatus according to claim 1, wherein the at least one memory further stores instructions for causing the at least one processor and the at least one memory to, in the case where the information processing apparatus operates based on the first operation setting, use, for the direct wireless communication, the frequency band set by the second setting for the direct wireless communication.

4. The information processing apparatus according to claim 1, wherein the at least one memory further stores instructions for causing the at least one processor and the at least one memory to, in the case where the information processing apparatus operates based on the first operation setting, use any one of the plurality of frequency bands for a search for the counterpart apparatus.

5. The information processing apparatus according to claim 1, wherein the at least one memory further stores instructions for causing the at least one processor and the at least one memory to, in the case where the information processing apparatus operates based on the first operation setting, use any one of the plurality of frequency bands for a communication connection with the counterpart apparatus.

6. The information processing apparatus according to claim 1, wherein the first operation setting is the operation setting for performing the direct wireless communication in compliance with a Wi-Fi Direct® standard.

7. The information processing apparatus according to claim 1, wherein any one of the information processing apparatus and the counterpart apparatus to be operated as a group owner and the other to be operated as a client are determined by the negotiation.

8. The information processing apparatus according to claim 1, wherein the information processing apparatus operates in an infrastructure mode in which communication with the counterpart apparatus is performed via the external access point, and performs communication in the 2.4 GHz band or the 5 GHz band in the infrastructure mode.

9. The information processing apparatus according to claim 8, wherein the information processing apparatus performs operation in the infrastructure mode and operation based on the second operation setting in parallel.

10. The information processing apparatus according to claim 8,
wherein, in a case where the information processing apparatus operates in the infrastructure mode, the information processing apparatus performs communication in the 2.4 GHz band or the 5 GHz band based on the connected external access point,
wherein, in the case where the information processing apparatus operates based on the first operation setting, the information processing apparatus fixedly uses the 2.4 GHz band for the direct wireless communication, and
wherein, in the case where the information processing apparatus operates based on the second operation setting, the information processing apparatus uses the 5 GHz band set by the second setting for the direct wireless communication.

11. The information processing apparatus according to claim 8, wherein the at least one memory further stores instructions for causing the at least one processor and the at least one memory to provide a setting screen for receiving a setting of a frequency band used in the infrastructure mode, the first operation setting, and the second operation setting each.

12. The information processing apparatus according to claim 1, wherein the at least one memory further stores instructions for causing the at least one processor and the at least one memory to provide a setting screen for setting a frequency band used in the direct wireless communication, the setting screen at least including an item indicating the 2.4 GHz band and an item indicating the 5 GHz band.

13. The information processing apparatus according to claim 1, wherein the at least one memory further stores instructions for causing the at least one processor and the at least one memory to provide a setting screen for setting the operation setting related to the direct wireless communication function to the first operation setting or the second operation setting.

14. The information processing apparatus according to claim 1, wherein the information processing apparatus is an image processing apparatus including a printing function, and prints image data acquired through communication.

15. A method of controlling an information processing apparatus capable of performing communication at least in a 2.4 GHz band and a 5 GHz band, and capable of performing a direct wireless communication function for performing direct wireless communication with a counterpart apparatus without an external access point, the method comprising:
as first setting, setting an operation setting related to the direct wireless communication function to a first operation setting with which a negotiation with a counterpart apparatus for determining which of the information processing apparatus and the counterpart apparatus is to be operated as an access point to perform the direct wireless communication or to a second operation setting with which the information processing apparatus operates as the access point without the negotiation to perform the direct wireless communication;
as second setting, setting a frequency band used in the direct wireless communication from among a plurality of frequency bands including the 2.4 GHz band and the 5 GHz band by receiving an operation from a user; and
controlling the information processing apparatus, in a case where the information processing apparatus operates based on the first operation setting, to use any one of the plurality of frequency bands for the direct wireless communication, and in a case where the information processing apparatus operates based on the second operation setting, to use the frequency band set by the second setting for the direct wireless communication.

16. A non-transitory computer-readable medium storing computer-executable instructions for causing an information processing apparatus, capable of performing communication at least in a 2.4 GHz band and a 5 GHz band and capable of performing a direct wireless communication function for performing direct wireless communication with a counterpart apparatus without an external access point, to perform operations comprising:
as first setting, setting an operation setting related to a direct wireless communication function for performing direct wireless communication with a counterpart apparatus without an external access point to a first operation setting with which a negotiation with a counterpart apparatus for determining which of the information processing apparatus and the counterpart apparatus is to be operated as an access point to perform the direct wireless communication or to a second operation setting with which the information processing apparatus operates as the access point without the negotiation to perform the direct wireless communication;
as second setting, setting a frequency band used in the direct wireless communication from among a plurality of frequency bands including the 2.4 GHz band and the 5 GHz band by receiving an operation from a user; and
in a case where the information processing apparatus operates based on the first operation setting, to use any one of the plurality of frequency bands for the direct wireless communication, and in a case where the information processing apparatus operates based on the second operation setting, to use the frequency band set by the second setting for the direct wireless communication.
